(19) United States
(12) Patent Application Publication
(10) Pub. No.: US 2026/0225061 A1
(43) Pub. Date: Aug. 6, 2026

(54) Expedited chemical reactions at curved microscale interfaces between water and a hydrophobic medium

(71) Applicants: The Board of Trustees of the Leland Stanford Junior University, Stanford, CA (US); King Fahd University of Petroleum and Minerals, Dhahran (SA)

(72) Inventors: Chanbasha Basheer, Dharmapuri DT (IN); Xiaowei Song, Menlo Park, CA (US); Yu Xia, Palo Alto, CA (US); Richard N. Zare, Stanford, CA (US)

(21) Appl. No.: 19/149,680

(22) PCT Filed: Jan. 25, 2024
(86) PCT No.: PCT/US2024/012974

§ 371 Date: Jul. 21, 2025

Related U.S. Application Data
(60) Provisional application No. 63/441,119, filed on Jan. 25, 2023.
(60) Provisional application No. 63/532,226, filed on Aug. 11, 2023.

(51) Int. Cl. B01J 19/00

(52) U.S. Cl. CPC B01J 19/0093; B01J 2219/0093

(57) ABSTRACT

Chemical reactions are expedited by exploiting contact electrification at curved microscale interfaces between water and a hydrophobic medium. The hydrophobic medium can be a solid, liquid, or gas. The microscale-interfaces can be surfaces of water droplets in contact with a hydrophobic medium, such as a gas, liquid, or solid, or they can be surfaces of gas microbubbles in contact with water alone or with water containing solid or liquid hydrophobic particles.

### FIELD OF THE INVENTION

This invention relates to performing chemical reactions more efficiently.

### BACKGROUND

Production of major industrial chemicals is often done by processes which demand significant resources and/or which have significant environmental impact. Two examples of this are the production of ammonia and urea, considered in turn below.

Large-scale ammonia production is achieved by the Haber-Bosch process in which nitrogen (N₂) and hydrogen (H₂) react at high pressure (80-300 atm) and high temperature (300-500° C.) in the presence of a catalyst (usually magnetic iron oxide, Fe₃O₄) to form ammonia: N₂+3H₂→2NH₃. The hydrogen source is usually methane (natural gas), which is reacted with steam at 700° C.-1,000° C. and 3-25 atm pressure. Hydrogen, carbon monoxide, and a relatively small amount of carbon dioxide are formed: CH₄+H₂O→CO+3H₂ (+ small amount of CO₂). Subsequently, the carbon monoxide and steam are reacted using nickel as a catalyst to produce carbon dioxide and more hydrogen: CO+H₂O→CO₂+H₂. Between 1.8 and 2.1 tons of CO₂ are emitted for every ton of NH₃ synthesized from H₂ by the Haber-Bosch process. In 2021, the amount of NH₃ produced exceeded 150 million metric tons, corresponding to producing roughly 300 million metric tons of CO₂ associated with H₂ from the steaming of methane. It is estimated that ammonia synthesis accounts for more than 2% of global energy consumption.

Large scale production of urea uses liquid ammonia and liquid carbon dioxide as reagents. These two materials are combined under high pressures and elevated temperatures to form ammonium carbamate, which then decomposes at much lower pressures to yield urea and water. So, a major cost in making urea is in making ammonia (NH₃). A typical modern ammonia-producing plant first converts natural gas, liquified petroleum gas, or petroleum naphtha into gaseous hydrogen. The method for producing hydrogen from hydrocarbons is known as steam reforming. The hydrogen is then combined with nitrogen to produce ammonia via the Haber-Bosch process.

Accordingly, it would be an advance in the art to provide improved synthesis of ammonia, urea and the like.

### SUMMARY

The core idea of this work is expediting chemical reactions by exploiting contact electrification at curved microscale interfaces between water and a hydrophobic medium. The hydrophobic medium can be a solid, liquid, or gas. The microscale-interfaces can be surfaces of water droplets in contact with a hydrophobic medium, such as a gas, liquid, or solid, or they can be surfaces of gas microbubbles in contact with water alone or with water containing solid or liquid hydrophobic particles. Here microscale refers to a radius of curvature of 30 microns or less. FIGS. 1 and 2 schematically show the main options. On FIG. 1 a water microdroplet 102 is in contact with a hydrophobic medium 104, such as a solid catalyst (although liquid and gas are also alternatives for hydrophobic medium 104), and the important interface is the surface of water microdroplet 102. On FIG. 2 a microparticle, microdroplet or microbubble of hydrophobic medium 204 is in contact with water 202. Here the important interface is the curved surface of hydrophobic medium 204. Microbubbles of hydrophobic medium 204 can be provided by bubbling gas through water. Microdroplets of hydrophobic medium 204 can be provided by emulsifying a hydrophobic liquid in water. Microparticles of hydrophobic medium 204 can be provided by suspending microparticles of a hydrophobic liquid in water. Reagents can be supplied to such an emulsion or suspension by bubbling the reagents through the emulsion or suspension (e.g., bubbling methane and/or CO₂ through a water-oil emulsion). In some cases, more than one constituent can be hydrophobic, e.g., when bubbling gas through an emulsion of water with a hydrophobic liquid or bubbling gas through a suspension of water with a hydrophobic solid.

We have found that large electric fields can be present at such curved interfaces (e.g., on the order of 107 V/cm), and that these fields can expedite water chemistry by generating reactive species such as H atoms and OH radicals to make reactions happen.

Three detailed examples are given below (urea synthesis, ammonia synthesis and methane oxidation). In general, we expect this approach to be broadly applicable to various chemical reactions. Other specific examples we have investigated include, but are not limited to: use of oil, water and CO₂ to produce CO in an oil-water emulsion, conversion of ammonia to molecular hydrogen using water microdroplets and UV radiation with a metal oxide catalyst, conversion of nitrate to ammonia using water microdroplets, and formation of phenol from benzoic acid using water microdroplets.

Significant advantages are provided. For example, our process enables a new form of nitrogen fixation that is expected to be less expensive than what has been done previously. The facts that we do not need to secure hydrogen and we use unwanted carbon dioxide directly in our process (for urea production) makes the process even more appealing. There is also no need for high-pressure and/or high temperature equipment.

### BRIEF DESCRIPTION OF THE DRAWINGS

FIG. 1 shows a first configuration relating to embodiments of the invention.

FIG. 2 shows a second configuration relating to embodiments of the invention.

FIG. 3A schematically shows urea production according to an embodiment of the invention.

FIG. 3B is a schematic micro-scale view of the reaction of FIG. 3A.

FIGS. 4A-D show experimental results relating to urea production.

FIG. 5 schematically shows ammonia production according to an embodiment of the invention.

FIGS. 6A-D show experimental results relating to ammonia production.

FIG. 7 schematically shows methane oxidation according to an embodiment of the invention.

FIG. 8 shows experimental results relating to methane oxidation.

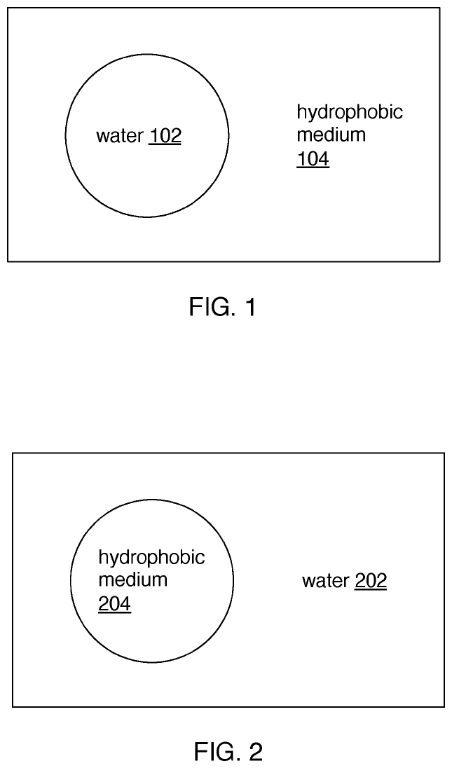

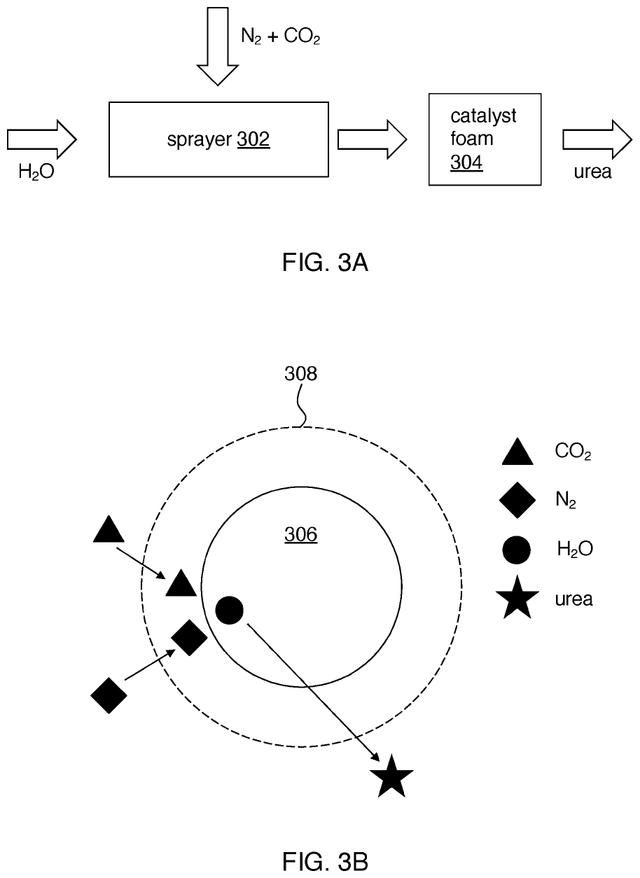

### DETAILED DESCRIPTION

### A) Urea Synthesis With Water Microdroplets

### A1) Introduction

Urea [CO(NH₂)₂] is the first organic molecule successfully synthesized in the laboratory, opening the field of organic chemistry. Today, over 190 million tons per year of urea are produced as fertilizer. This is accomplished by adding liquified carbon dioxide (CO₂) to liquid ammonia (NH₃) under harsh conditions (400-500 K and 150-250 bar). The use of high temperatures has the drawback of easily introducing degradation and unwanted byproducts such as biuret, cyanuric acid, ammelide, ammeline, and melamine. Ammonia is synthesized from nitrogen (N₂) and hydrogen (H₂) by the Haber-Bosch process under high pressure and high-temperature conditions (100-200 psi, 400-500° C.), which is sufficient to break the NEN triple bond (941 KJ mol⁻¹). This process accounts for more than 2% of the global energy consumption. The hydrogen comes from a petroleum source (methane) by reaction with steam, adding to the negative environmental impact through the release of about 1% of the carbon dioxide found in the atmosphere. Viable urea synthetic approaches under milder conditions are widely being sought to reduce environmental pollution from the present industrial process.

Extensive efforts have been put into developing new functional molecules and materials for heterogeneous photo-/electrocatalytic reduction to yield urea. Metal oxides (e.g., TiO₂, Fe₂O₃, and Bi₂O₃), metal borides (e.g., Mo₂B₂, Cr₂B₂), and metal complexes (e.g., tetrahexahedral Au and iron phthalocyanine) are prepared in various nanomaterials as catalytic electrodes. A copper bismuth oxide has been previously reported to synthesize urea electrochemically.

Recently, Pd/Cu alloy nanoparticles on TiO₂ nanosheets were reported to be an effective electrocatalyst that can produce urea from N₂ and CO₂ dissolved in H₂O with a formation rate of 3.36 mmol g⁻¹ h⁻¹, which appears to be a remarkable breakthrough in green urea synthesis. However, the poor solubility of N₂ in water and the postseparation of NH₃ from the aqueous electrolyte complicate the subsequent steps of urea synthesis.

Water can serve as one of the cleanest natural sources of hydrogen on earth for N₂ fixing and for the capture of CO₂ from the air and conversion to value-added products.

Physically, spraying water microdroplets sized at around 10 μm can gain a 10,000 times larger contacting interface than the equal volume of bulk water. Therefore, water microdroplets facilitate the incorporation of the gas-phase substrates into a heterogeneous reaction system by sufficient contact with a solid catalyst, increasing the catalytic performance rather than being dissolved in a bulk solution. Recently, we have demonstrated how nitrogen can be converted to ammonia using water microdroplets combined with a catalyst. These issues motivated us to search for a simpler reaction system beyond the conventional paradigm of photo/electrocatalysis for making urea.

### A2) Experimental Setup

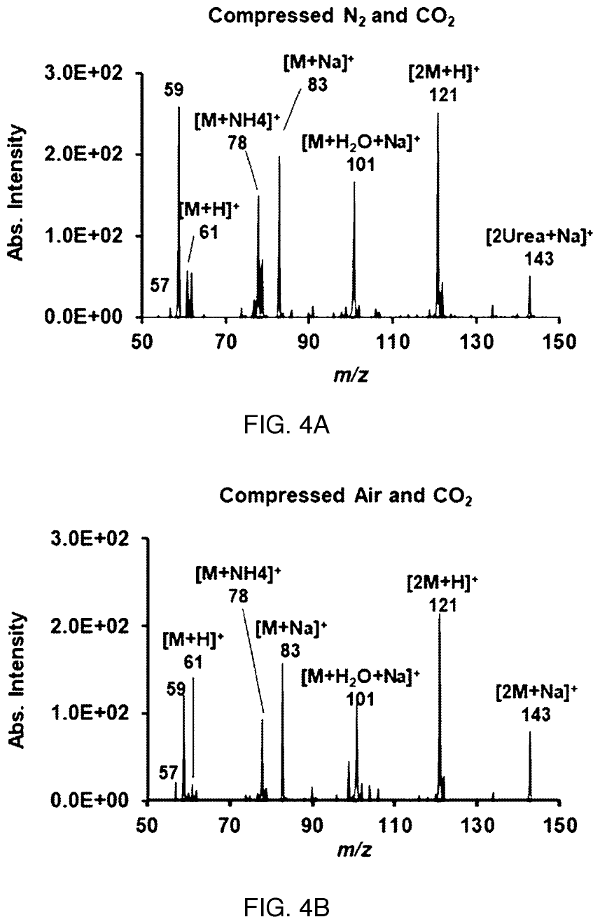

FIG. 3A schematically shows the experimental setup for urea production. Water microdroplets are sprayed with a 1:1 mixture of N₂ and CO₂ as nebulizing gas from a sprayer 302. The microdroplets strike a graphite mesh coated with CuBi₂O₄ (referred to as catalyst foam 304 on FIG. 3A) and pass through the mesh, where they are analyzed with a mass spectrometer. The CuBi₂O₄ catalyst is synthesized by a one-step hydrothermal reaction. The system represents a gas-liquid-solid heterogeneous catalytic system for producing urea.

As starting materials, CO₂ and N₂ were first fed into the triphase catalysis system from cylinders containing the compressed gases. The copper bismuth oxide catalyst was characterized by transmission electron microscopy and X-ray diffraction.

FIG. 3B schematically shows this reaction at micro-scale. Here 306 is a water microdroplet in proximity to catalyst 308 (which can be, for example, a graphite wire in a graphite mesh that is coated with CuBi₂O₄ as described above), and the indicated symbols for molecules schematically show the reaction occurring at the interface of a water microdroplet 306.

### A3) Results/Discussion

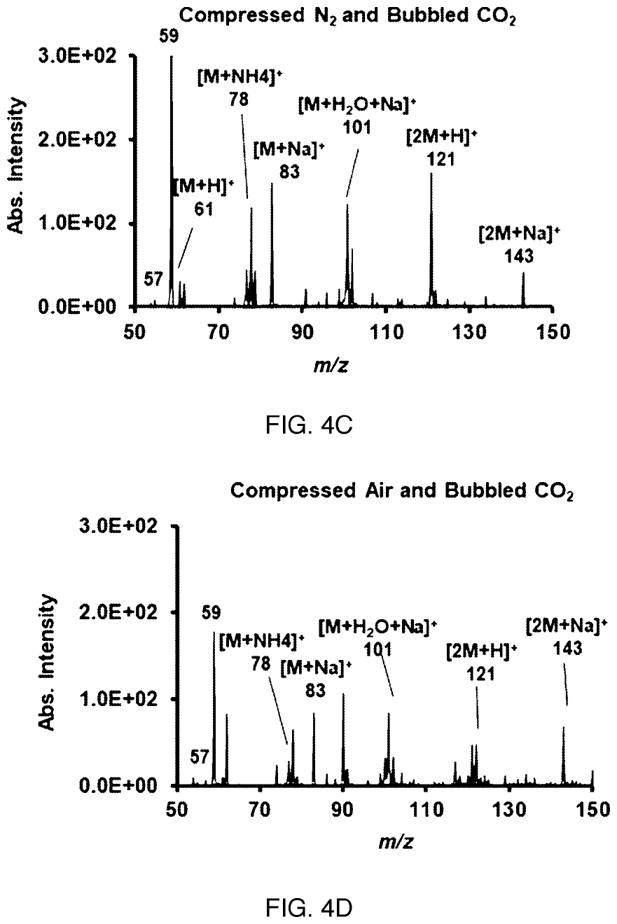

As an initial condition, zero external voltage was applied to the catalyst mesh and the sonic sprayer. Several urea-associated peaks can be observed in the mass spectrum (FIG. 4A). Apart from the urea monomer ion (m/z 61, [urea+H]+; m/z 83, [urea+Na]+), the generated urea also exists as forms of a dimer (m/z 121, [2urea+H]+; m/z 143, [2urea+Na]+) due to the intermolecular hydrogen bonding, which may indicate a considerable urea yield. In addition, the existence of an ammonium-adducted urea peak (m/z 78, [urea+NH4]+) revealed that ammonia is also generated as a byproduct in the synthesis of urea. Based on its ion intensity, this ammonia accounted for approximately 12% of the total amount of urea. Apart from the final product, urea, two adsorbed intermediates [NCON+H]+(m/z 57) and [HNCONH+H]+(m/z 59) were also detected in the mass spectrum, which will be further discussed in proposing a mechanism.

However, when replacing the water flow with methanol, urea-associated MS signals gradually disappeared. This negative control illustrates the critical role of water microdroplets in the formation of urea as the source of reduced protons and free electrons. When the CO₂ gas supply was stopped, and the native CO₂ dissolved in water was completely removed, there was also no urea-associated peak observed. Apart from water microdroplets, the surface hydrophobicity of the graphite support is another contributing factor that could influence urea production. When we replaced the mesh of hydrophobic graphite with a hydrophilic copper foam, only a weak urea signal could be observed from the mass spectrum. The atomized water microdroplets may be recondensed into the bulk form when passing through the hydrophilic porous medium. It not only shortens the survival time of microdroplets but also suppresses the ionization of the urea product. In contrast, a hydrophobic medium (contact angle 113°) can make sprayed microdroplets survive in a higher amount and a longer period because of the weak surface tension between liquid and solid phases.

We also investigated the use of compressed air containing 78% N₂ as the nitrogen source, as well as using CO₂ dissolved in the water. We found that the urea abundance was not seriously affected by the less pure starting N₂ and by the physical status of CO₂ (FIGS. 4B-C). These results demonstrate the robustness of the proposed heterogeneous catalysis system. It also indicates the promising potential for selecting more widely available starting materials for urea synthesis. When simultaneously feeding compressed air and bubbling CO₂ into water, the urea mass peak suffered some loss in intensity, but major urea-associated peaks can be successfully observed in the mass spectrum (FIG. 4D).

Mounting evidence has confirmed the theoretical claim about the existence of an ultrahigh electric field (10⁹ V/m) across the air-water interface of microdroplets, which is sufficient to induce spontaneous redox reactions. In addition, contact electrification between water and a solid surface is another crucial physicochemical process at water-solid interfaces. Contact electrification between water-solid, water-gas, and solid-gas causes interfacial charge/electron transfer and separation. Extremely close contact between any of the above two phases may also generate a strong static electric field to drive the C—N coupling and redox reaction. In general, spraying water microdroplets provided a very special physiochemical environment to promote urea formation under no external photo/electro-catalytic conditions.

From the chemical aspect, mounting evidence in the previous studies shows that the water microdroplet interface has spontaneous redox ability driven by its unique physicochemical properties such as the interfacial electric field, orientated molecular alignment, partial solvation, spontaneous redox, and contact electrification between the water-hydrophobic medium (gas, liquid, or solid) interface. Given the above rationales, it is expected that water microdroplets serve not only as the interaction medium that bridges the gas phase substrate and solid phase catalyst but also as proton and electron donors for nitrogen hydrogenation and urea synthesis. The ability of water microdroplets to donate electrons has been recognized previously. This system is special in that it involves the simultaneous reaction of reagents in the gas, liquid, and solid states.

### A4) Conclusions

This work presents the formation of urea starting from N₂ and CO₂ under the aid of water microdroplets and a CuBi₂O₄ catalyst. We believe this is an essential advance in demonstrating the power of water microdroplet chemistry.

Multiple urea formation steps, including N₂ absorption, N═N bond cleavage, nitrogen hydrogenation, and C—N bond formation, were processed in the liquid/gas, gas/solid, and liquid/solid interfaces at the submillisecond time scale without harsh conditions in temperature and high pressure and with no external applied voltage. The catalytic system has been operated for roughly 1 h with no apparent change in urea production rate. Water microdroplets are essential to causing this process to occur. It is believed that the water microdroplet interface donates protons and electrons to cause the synthesis of urea in contact with the CuBi₂O₄ catalyst. It remains to be investigated whether this catalyst is an optimum choice and how long it can be operated without any degradation. How promising this synthesis might be for urea production on an industrial scale is presently unestablished. We believe that this requires further work on scaling water microdroplet chemistry.

### B) Ammonia synthesis via contact electrification

### B1) Introduction

Ammonia (NH₃) is integral to both agricultural and industrial applications, serving as a foundational element in fertilizers and diverse chemical reactions. The synthesis of ammonia is generally achieved by the hydroreduction of nitrogen gas (N₂) in the presence of catalysts. Currently, the Haber-Bosch process is the dominant method for ammonia synthesis by using fossil fuel-derived hydrogen as the proton donor at high temperatures and pressures, consuming approximately 1.4% of the world's energy supply and emitting close to 400 million tons of CO₂ annually. Using water (or even humidified air) instead of H₂ as the proton source for ammonia synthesis under room temperature and atmospheric pressure is a green and sustainable alternative to the Haber-Bosch process, which will reduce energy consumption and CO₂ emission during ammonia synthesis. The task is challenging because the reaction process theoretically requires a constant supply of electrons and protons (which can also be in the form of hydrogen atoms) to activate the nitrogen and subsequent reduction reactions. Despite recent developments in ammonia synthesis based on electrocatalysis and photocatalysis, they are often limited by the fact that most protons and electrons in those systems prefer to recombine to produce hydrogen rather than reduce nitrogen.

Recently, several works have reported that the contact electrification at water-gas interface and water-solid interface can cause electron transfer at their interface and the generation of reactive oxygen species and hydrogen radicals. The contact between water and polytetrafluoroethylene (PTFE) particles, a commercial dielectric material, can catalyze unexpected redox reactions occurring at the interface. Moreover, recent work has shown that ammonia can generate at the interface between aqueous microdroplets and nitrogen gas, raising hopes for continuous reduction of nitrogen to ammonia during contact electrification. Herein, we describe an approach for ammonia synthesis based on the reaction between protons in water and N₂ adsorbed on the surface of PTFE particles during contact electrification without additional electrical energy or radiation. In this system, ultrasonic waves promote continuous contact between water and solid particles to achieve continuous ammonia synthesis.

### B2) Materials and Methods

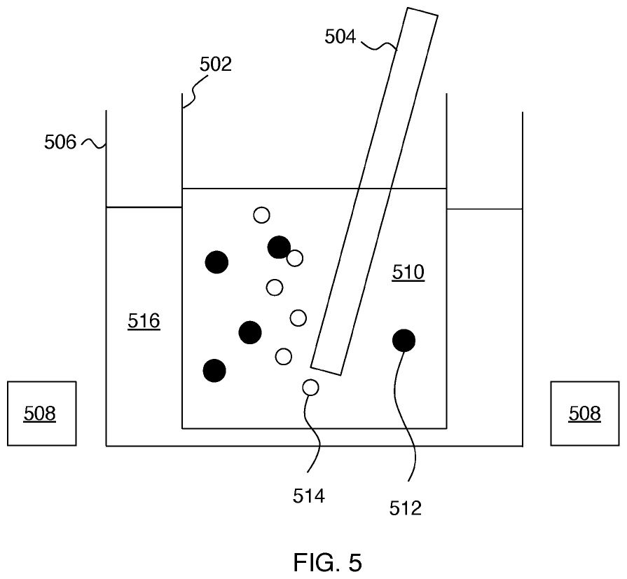

To investigate whether ammonia can be generated from nitrogen adsorbed on the PTFE surface during the water-solid contact, a reaction system was constructed as schematically shown in FIG. 5. This system includes three integral components: ultrasonication, temperature control, and gas introduction. A temperature-controlled circulating water system (here shown schematically as outer water bath 516) integrated with a copper coil was used to regulate the reaction temperature within the range of 10 to 50° C. The ultrasonic source 508 operated at a frequency of 40 kHz with an adjustable power output ranging from 0 to 100 W. Gases (nitrogen, air, or nitrogen-oxygen mixtures) were bubbled into the PTFE suspension 510 at 5 kPa via nozzle 504, serving as the nitrogen source for the ammonia synthesis. A cylindrical porous mineral bubbler (about 5 cm in diameter) called an air stone is used to create microbubbles of gas.

The bubbles that are blown into the sample are not a single large bubble but densely packed with bubbles having diameters ≤500 μm, which results in most contact occurring at the gas-liquid-solid triphasic interfaces. In addition, the surfactant Tween 20 (<0.05 vol. %) was added to the solution to help the PTFE disperse in the water. It was found that the addition of this surfactant did not appreciably diminish the observed reaction rate. Other components shown on this figure are reaction vessel 502, outer vessel 506, PTFE particles 512 (filled circles) and gas bubbles 514 (open circles).

### B3) Results

A quantitative evaluation of the amount of ammonia generated was achieved using the indophenol blue method, which results in the dye-ammonium complex exhibiting an absorption peak at 650 nm. Standard curves were constructed using ammonium chloride solutions at different concentrations (0, 5, 10, 20, and 30 μM). Using UV-vis spectroscopy, we assessed the ammonia concentration for different ultrasonication durations, revealing a linear time-dependent increase in ammonia-dye absorption with increased exposure. Our data also indicate oxygen introduction augments the H₂O₂ concentration while simultaneously decreasing the ammonia concentration.

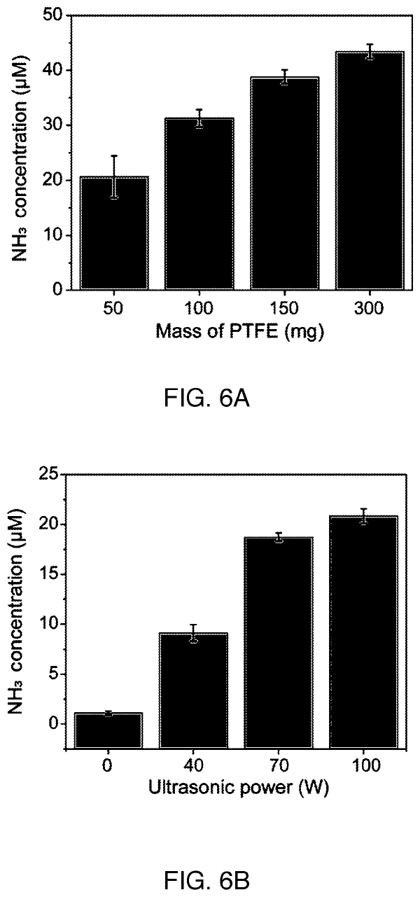

To understand better the action of PTFE on the synthesis of ammonia, we investigated the relationship between the mass of PTFE in the suspension and the concentration of ammonia. The results, displayed in FIG. 6A, showed that the ammonia yield increases in a nonlinear fashion with increasing PTFE mass, reaching 21 μmol L⁻¹ h⁻¹ at 50 mg, 31 μmol L⁻¹ h⁻¹ at 100 mg, 39 μmol L⁻¹ h⁻¹ at 150 mg, and 43 μmol L⁻¹ h⁻¹ at 300 mg. Averaging the total ammonia production rate per gram of catalyst, the most efficient and cost-effective performance was observed with 50 mg of the catalyst, which showed a reaction rate of ~420 Mmol L⁻¹ h⁻¹ g⁻¹.

Control experiments were conducted, such as without ultrasonication and instead resorting to mechanical stirring. In the two control groups, it was observed that simply blowing nitrogen into the sample for 1 h without stirring resulted in an ammonia concentration of approximately 3 μmol L⁻¹ h⁻¹. In contrast, introducing mechanical stirring while blowing nitrogen for the same duration led to an ammonia concentration nearing 9 μmol L⁻¹ h⁻¹. This result indicates that the contact and separation at the triphasic interface (PTFE-water-N₂ gas) plays a key role in the production of ammonia.

We previously discussed the effect of even a slight amount of Oz on ammonia production. As a result, the dissolved oxygen in water should be considered. The yield of ammonia in DI water without deoxygenation is 14 μmol L⁻¹ h⁻¹, whereas DI water deoxygenated with nitrogen gas for 30 min yields up to 21 μmol L⁻¹ h⁻¹ using 50 mg PTFE. Further deoxygenation of 60 min does not substantially increase the yield, suggesting that 30 min is sufficient to remove dissolved oxygen.

FIG. 6B presents data on how the ammonia yield depends on ultrasonic power. The ultrasonic frequency affects the contact frequency between particles and water, while the ultrasonic power controls the intensity of contact between PTFE particles and other molecules. As ultrasonic power increases, the operative distance between molecules decreases, resulting in a concomitant rise in ammonia yield (from 0 to 21 μmol L⁻¹ h⁻¹).

The ammonia yield is also influenced by the reaction temperature. As shown in FIG. 6C, increasing the temperature from 10 to 25° C. enhances ammonia yield because of a more favorable thermodynamic environment for electron transfer. However, at temperatures exceeding 50° C., ammonia yield decreases (from 21 to 11 μmol L⁻¹ h⁻¹). This decline occurs because the ultrasonic cavitation effect produces highly localized temperatures and pressures. When temperatures in the environment reach high levels, they impede the diffusion of heat, potentially triggering unfavorable electron reactions. Therefore, it is preferred to maintain an appropriate temperature to achieve a high yield of ammonia. In addition, the ammonia yield is closely related to the pH of the PTFE suspension. As shown in FIG. 6D, a suspension that is either too acidic or too alkaline will adversely affect the ammonia yield. We believe this observation can be attributed to the difference of the arrangement of water molecules at solid surface affected by pH. More specifically, we propose that at acidic pH, the protonation of C—F bonding at the interface is fast, leading to recombination between the H+ and electron; while at basic pH, the proton can easily diffuse away from the surface. Both above conditions inhibit the reaction between reactive nitrogen adsorbed on PTFE and protons generated during the contact. Therefore, we believe that we can make the electrons and protons react with nitrogen continuously at neutral pH.

Under the established optimal conditions (50 mg of PTFE in 100 mL of deoxygenated DI water, 100 W ultrasonic power, 25° C.), the reaction was run for a total duration of 8 h.

The ammonia yield remained largely invariant within the initial 4 h. Subsequently, the synthesis rate exhibited a decline, culminating in an almost complete cessation by the end of the 8 h duration. A probable causal factor for this observed trend is the concomitant elevation in the pH of the PTFE suspension as the reaction advanced, which in turn could modulate the reaction kinetics. Concomitant with the reaction's evolution was a discernible increase in the pH of the suspension, potentially serving as the primary determinant governing the reaction rate. To corroborate this postulation, we scrupulously maintained the pH of the suspension within a 6.5 to 7 range, necessitating hourly pH adjustments. With this stringent pH oversight, the ammonia yield (~21 μmol L⁻¹ h⁻¹) remained predominantly stable across the 8-h reaction duration. This result shows that the ammonia synthesis process based on contact electrification between water and PTFE offers a promising possibility of producing ammonia from the reaction of nitrogen and water continuously under mild conditions. More importantly, our finding holds the promise of replacing the hydrogen gas required for the Haber-Bosch process with water, enabling the ammonia industry to reduce its dependence on fossil fuels for hydrogen production and thereby reducing the industry's carbon dioxide emissions on a global scale (which in 2020 was 2.6 tons of CO₂ per ton of ammonia).

### B4) Conclusion

In this work, we synthesized ammonia from nitrogen gas during the contact between water and PTFE. In this system, N₂ plays a crucial role as the nitrogen source for ammonia, while water acts as the proton donor. ESR (Electron spin resonance) results and DFT simulations demonstrated that radical intermediates regulate the reaction pathway, offering a perspective on the autonomous control of radical reactions in-contact electrocatalysis. Moreover, by optimizing experimental parameters and comparing the oxidative and reductive products (H₂O₂ and NH₃) under varying conditions, we have found some general principles affecting contact electrocatalysis. By strictly controlling the pH of the suspension, we also demonstrated that this method can continuously generate ammonia over an 8-h period without any appreciable change in the reaction rate. Our findings deepen the understanding of contact electrocatalysis and suggest its possible use in scaling up such reactions.

### C) Methane Oxidation Using Water Microdroplets

C1) Introduction Methane (CH₄), as the major component in natural gas, accounts for approximately 30% of the global temperature rise since the industrial revolution. It is a potent greenhouse gas with a global warming potential of 25 times that of carbon dioxide (CO₂). Unfortunately, there is no effective method to remove methane from the air. Oxidation of methane to CO₂ is one of solutions that could reduce methane's 20-year global warming impact by 99%. Catalytic combustion requires a temperature of higher than 400° C. to convert CH₄to CO₂ at 90% efficiency, making it a highly energy-intensive process. There is often severe performance degradation under such hydrothermal conditions, making high-temperature catalytic combustion for dilute and atmospheric methane removal unviable. These challenges motivate us to seek solutions for atmospheric methane removal that mimic natural methane degradation processes at ambient temperatures and pressures. These natural processes rely on free radical reactions, primarily using hydroxyl radicals (OH·).

Converting methane to methanol is another considerable way to reduce methane gas emission because of its significant cost advantages in transportation and storage. Converting methane to methanol through partial oxidation at room temperature has remained a challenging issue in catalysis for decades. The CH₄ molecule has a tetrahedral shape, which confers stability and a nonpolar nature. The difficulty arises not only from the strong bonding energy of the C (sp³)-H bond (439 kJ mol⁻¹) but also the overoxidation tendency, leading to the formation of CO₂. Mounting research has suggested H₂O₂ as an excellent oxidant for converting methane to methanol because of its green oxidation byproduct (water).

It has been suggested that the hydroxyl radical (OH·) is a better choice to initiate methane oxidation by producing the methyl radical (CH₃·). Hydroxyl radicals are certainly how nature removes methane from the atmosphere.

Photocatalysis, electrocatalysis, biocatalysis, and ultra-sound-assisted catalysis for methane oxidation at room temperature heavily rely on sophisticated catalyst designs. A catalyst-free method was poorly studied previously.

There is compelling evidence that the hydroxyl radical can be formed in multiple ways in water microdroplets, particularly its air-water interface (AWI). One way is the direct transfer of single electron from the hydroxyl anion (OH) to generate the hydroxyl radical (OH⁻→OH·+e) facilitated by the strong electric field across the AWI (10⁷ V/cm). Another way involves single-electron transfer from the OH⁻ to H⁺ (H⁺+OH⁻→H·+OH·), which is reported as a thermodynamically favorable process in the AWI region (ΔH=−375 KJ mol−1). Many spontaneous redox reactions across the AWI have been successfully observed during this process.

Furthermore, the charge transfer during contact electrification between the water-solid and water-gas interfaces also contributes to the abundant presence of OH·. With aid of the generated OH. across the AWI, organic syntheses have been readily achieved by the radical-initiated C (sp³)-H activation of toluene in water microdroplets such its C—N coupling with amines and its C—C coupling with carbon dioxide.

### C2) Methods

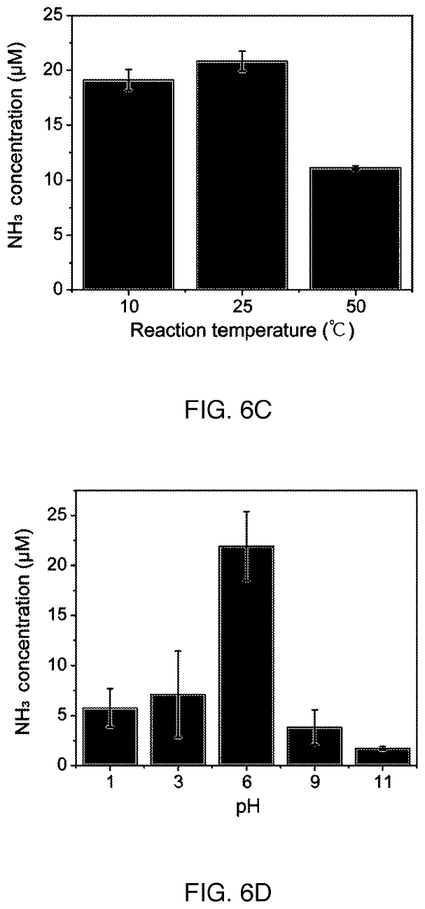

Inspired by the unique redox properties and previous studies, we are motivated to explore the potential of water microdroplets in the partial oxidation of methane (POM). FIG. 7 schematically depicts the experimental setup for the POM procedure. Methane gas and air were first pumped from compression cylinders and then mixed in various ratios (1:0, 1:1, 3:1, and 9:1) in a mixer 702. A syringe pump was employed to transport liquid water (10 μL/min) to the nozzle spray outlet of nozzle sprayer 704. The methane-air gas mixture under high pressure (100 psi) then nebulized the bulk water into numerous small microdroplets (12.5±7.5 μm average diameter). Through contact between water microdroplets and the methane-air gas mixture, free radical reactions are initiated leading to the production of methanol as one of the expected products. In some experiments, ultrasonication 710 (in this case at 40 kHz) and UV light (253.7 nm, 5 W) were also investigated to achieve the maximum oxidation and optimal selectivity of the methanol product. The reaction solution 708 was collected in a 10 mL tube 706 with a closed cap. Each reaction cycle was run for 30 min.

### C3) Results

The products of methane oxidation were first identified by a gas chromatograph (GC) equipped with a flame ionization detector (FID). The retention time (tr) of methanol was compared and matched by injecting a commercial standard. The methanol standard (100 ppm, dissolved in water) can be eluted with the gradually rising GC capillary temperature. The peak at 5.191 min represents methanol, which is followed by a strong water peak at 6.007 min. From the chromatogram of the sample, it was clearly seen that there is a peak at 5.193 min that closely matches the methanol standard retention time. Apart from methanol, there are also five additional peaks well separated in the time window from 4.0 to 7.0 min. The peak of ethanol (tr=5.359 min) is successfully recognized by comparison with the corresponding standard.

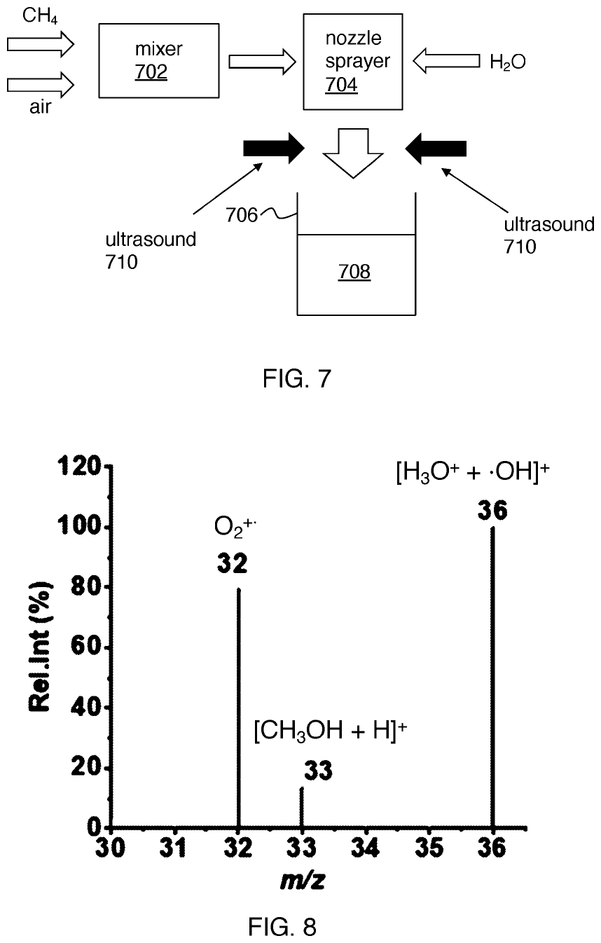

The methanol generated by spraying water with CH₄ gas was confirmed by a linear ion trap mass spectrometer (LTQ-MS). Nanoelectrospray ionization (nESI) was employed for introducing the sample solution into the MS system. From the mass spectrum in the range (m/z 30-36), the peak at m/z 33 can be observed, which is identified as protonated methanol ([M+H]+, FIG. 8). In contrast, no m/z 33 ion can be detected from negative control samples that either sprayed water with nitrogen gas or sprayed acetonitrile with methane gas. The peak at m/z 33 weakened when H₂O was replaced with D₂O (D₂O —H₂O, 9:1, v/v). Instead, deuterated methanol peaks were observed at m/z 34 ([CH₃OD+H]⁺) and 35 ([CH₃OD+D]⁺), indicating the involvement of the hydroxyl radical during the POM process. Additional evidence for the hydroxyl radical's involvement is the detection of a peak at m/z 36, which is the hydroxyl radical combined with a hydronium cation.

### C4) Conclusion

In summary, we have presented a method for the partial oxidation of methane under ambient conditions with no involvement of photocatalysis or electrocatalysis. The introduction of O₂ by using air as the nebulizing gas increases methane oxidation, but excess O₂ is to be avoided. We also find that ultrasonication creates more OH. radicals by cavitation and makes more microdroplets that together convert more methane to methanol. The highest conversion rate is obtained by using air as the nebulizing gas, combined with ultrasonication for droplet generation. The water microdroplet interface has been proven to be a reactive environment for methane oxidation.

1. A method for performing a chemical reaction, the method comprising:
delivering two or more reagents to a curved microscale interface between water and a hydrophobic medium;
wherein contact electrification at the curved micro-scale interface generates H atoms and OH radicals to make the chemical reaction happen.

2. The method of claim 1, wherein the interface is a surface of a water microdroplet.

3. The method of claim 2, wherein the hydrophobic medium is a gas.

4. The method of claim 2, wherein the hydrophobic medium is a liquid.

5. The method of claim 2, wherein the hydrophobic medium is a solid.

6. The method of claim 1, wherein the interface is a surface of a gas microbubble in water.

7. The method of claim 1, wherein the interface is a surface of a gas microbubble in water containing a hydrophobic liquid.

8. The method of claim 1, wherein the interface is a surface of a gas microbubble in water containing a hydrophobic solid.

9. The method of claim 1, wherein the interface is a surface of a hydrophobic liquid microdroplet in water.

10. The method of claim 1, wherein the interface is a surface of a hydrophobic solid microparticle in water.
